(19) United States
(12) Patent Application Publication
(10) Pub. No.: US 2026/0042343 A1
(43) Pub. Date: Feb. 12, 2026

(54) GRILLE SHUTTER DEVICE

(71) Applicant: TOYOTA JIDOSHA KABUSHIKI KAISHA, Toyota-shi (JP)

(72) Inventor: Katsuichiro HIRAKAWA, Toyota-shi (JP)

(73) Assignee: TOYOTA JIDOSHA KABUSHIKI KAISHA, Toyota-shi (JP)

(21) Appl. No.: 19/097,126

(22) Filed: Apr. 1, 2025

(30) Foreign Application Priority Data
Aug. 6, 2024 (JP) 2024-129629

(51) Int. Cl. B60K 11/08

(52) U.S. Cl. CPC B60K 11/085

(57) ABSTRACT

A grille shutter device includes a rotator. The rotator is disposed in the air introduction passage and is rotatable about an axis extending in the vehicle width direction. The rotator includes a closing plate extending in the vehicle width direction, a counter plate provided opposite to the closing plate, a pair of side plates connecting both ends of the closing plate and the counter plate in the vehicle width direction, and a plurality of grille plates connecting the closing plate and the counter plate with an interval in the vehicle width direction between the pair of side plates. The rotator has a falling posture in which the closing plate closes the opening by being rotated by the actuator about the axis, and a raised posture in which a plurality of grille plates appear in the back of the opening in the front view of the vehicle.

### CROSS-REFERENCE TO RELATED APPLICATION

This application claims priority to Japanese Patent Application No. 2024-129629 filed on Aug. 6, 2024. The disclosure of the above-identified application, including the specification, drawings, and claims, is incorporated by reference herein in its entirety.

### BACKGROUND

### 1. Technical Field

The present specification discloses a grille shutter device that opens and closes an opening of a vehicle front portion.

### 2. Description of Related Art

At the front end of a vehicle, a grille opening is provided to introduce traveling air into a vehicle body. A grille shutter device is provided behind the grille opening to adjust the air volume of the traveling air flowing into the vehicle body.

Japanese Unexamined Patent Application Publication No. 2019-51864 (JP 2019-51864 A) discloses a grille shutter device including a plurality of fins. In this grille shutter device, the fins are arranged in an up-down direction to be rotatable about an axis extending in a vehicle width direction. When the fins are in a fully closing position, the upper and lower tips of the fins adjacent to each other in the up-down direction overlap to close the opening. When the fins are in a fully opening position, the fins adjacent to each other in the up-down direction are parallel to each other to open the opening.

### SUMMARY

In the grille shutter device described in JP 2019-51864 A, it is necessary to operate the fins in conjunction with each other to open and close the opening. Therefore, the configuration of the device may be complicated. There is a demand for a grille shutter device that can simply open and close an opening extending in a vehicle width direction at a vehicle front portion.

The present specification discloses a grille shutter device that simply opens and closes an opening at a vehicle front portion.

The grille shutter device disclosed in the present specification is a grille shutter device to be applied to a vehicle that introduces air into a vehicle body through an opening extending in a vehicle width direction at a vehicle front portion.

The grille shutter device includes a rotator disposed in an introduction passage for the air and rotatable about an axis extending in the vehicle width direction.

The rotator includes:
a closing plate extending in the vehicle width direction;
a counter plate provided to face the closing plate;
a pair of side plates connecting both ends of the closing plate and the counter plate in the vehicle width direction; and
a plurality of grille plates connecting the closing plate and the counter plate with intervals in the vehicle width direction between the side plates.

The rotator is configured to take, by being rotated about the axis by an actuator:
a falling posture in which the closing plate closes the opening; and
a raised posture in which the grille plates appear behind the opening in a front view of the vehicle.

In this configuration, the fully closed state of the opening can be formed in the falling posture of the rotator, and the fully open state of the opening can be formed in the raised posture of the rotator. Therefore, the configuration of the grille shutter device can be simplified. Since the opening is closed by one surface of the closing plate, a decrease in aerodynamic performance during vehicle traveling can be suppressed. In the falling posture of the rotator (fully closed state of the opening), the grille plates are located with intervals in the vehicle width direction behind the closing plate. Therefore, it is possible to suppress backward deflection of the closing plate due to the vehicle traveling air. In the raised posture of the rotator (fully open state of the opening), the grille plates appear behind the opening. Therefore, it is possible to suppress entry of foreign matter into the vehicle body from the outside.

In the grille shutter device of the present disclosure, the counter plate of the rotator may be inclined upward from a front to a rear in the raised posture of the rotator.

With this configuration, the traveling air taken in through the opening can be guided upward in the vehicle body by the counter plate of the rotator. In this configuration, when the rotator makes transition from the raised posture (fully open state of the opening) to the falling posture (fully closed state of the opening), the traveling air hits the front portion of the counter plate ahead of the rear portion. Therefore, the rotation of the rotator is accelerated. Thus, the required torque of the actuator that rotates the rotator (output torque required from the actuator) can be reduced.

In the grille shutter device of the present disclosure, the rotator may further include air guide plates each disposed between the grille plates and inclined upward from a front to a rear in the raised posture of the rotator.

With this configuration, the traveling air taken in through the opening can be guided upward in the vehicle body by the air guide plates of the rotator. In this configuration, when the rotator makes transition from the raised posture (fully open state of the opening) to the falling posture (fully closed state of the opening), the traveling air hits the front portion of the air guide plate ahead of the rear portion. Therefore, the rotation of the rotator is accelerated. Thus, the required torque of the actuator that rotates the rotator can be reduced. With this configuration, the rigidity of the rotator can be improved by the air guide plates.

In the grille shutter device of the present disclosure, the axis of the rotator may be located between the closing plate and the counter plate, and a front end of the counter plate in the raised posture of the rotator may approach a lower surface of the introduction passage for the air when the rotator makes transition from the falling posture to the raised posture.

With this configuration, the required torque of the actuator that rotates the rotator can be reduced as compared with the case where the axis of the rotator is located on the counter plate. When the rotator makes transition from the falling posture to the raised posture, it can be expected that the front end of the counter plate pushes forward the foreign matter entering the lower surface of the air introduction passage and discharges the foreign matter through the opening.

In the grille shutter device of the present disclosure, the rotator may include a pair of rods having the axis and extending outward in the vehicle width direction from the side plates, and at least one of the rods may be rotated by the actuator.

With this configuration, the rotation of the rotator is realized by driving at least one of the rods.

With the technology disclosed in the present specification, it is possible to simply open and close the opening at the vehicle front portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a partial cross-sectional side view showing a rotator 32 of a grille shutter device and its periphery, and showing a falling posture FP of the rotator 32;

FIG. 2 is a perspective view showing the rotator 32 of the grille shutter device, and shows the raised posture RP of the rotator 32;

FIG. 3 is a partial cross-sectional side view showing the intermediate posture MP of the rotator 32;

FIG. 4 is a partial cross-sectional side view showing the raised posture RP of the rotator 32; and

FIG. 5 is a partial cross-sectional side view illustrating a raised posture RP of another rotator 32A.

### DETAILED DESCRIPTION OF EMBODIMENTS

Hereinafter, embodiments will be described with reference to the drawings. In all the drawings, equivalent elements are denoted by the same reference numerals, and redundant description is omitted. In the following description, unless otherwise specified, the terms indicating the front-rear, right-left, and up-down, etc. directions indicate the directions related to a vehicle. In the drawings, the direction of the arrow FR indicates the front side, the direction of the arrow UP indicates the upper side, and the direction of the arrow RH indicates the right side.

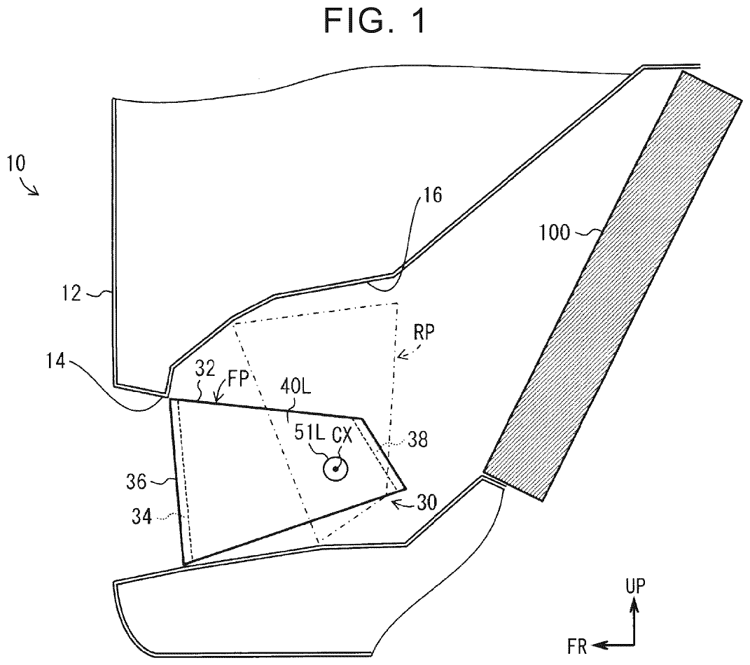

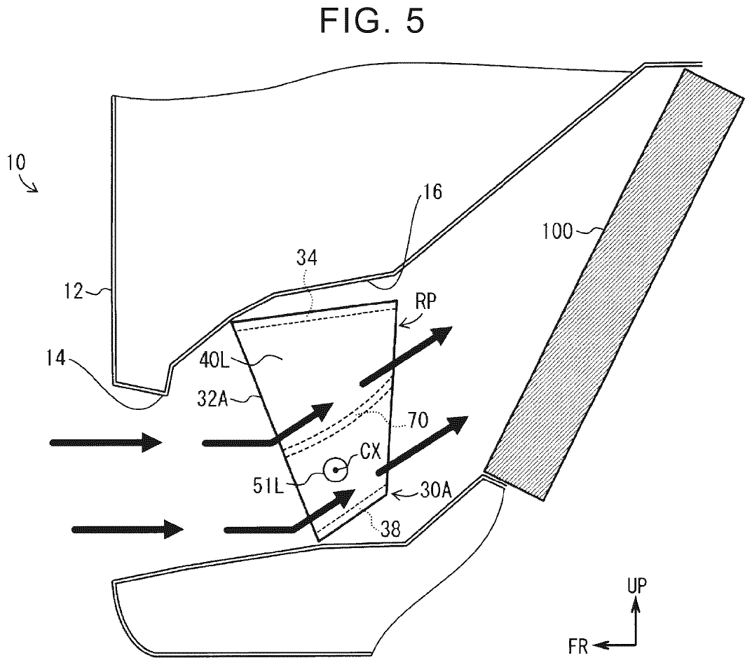

FIG. 1 is a partial cross-sectional side view showing a rotator 32 of a grille shutter device 30 mounted on a vehicle 10 and the periphery thereof, and shows a falling posture FP of the rotator 32. FIG. 1 and FIGS. 3 to 5, which will be described later, show a left side surface of the rotator 32 (the rotator 32A in FIG. 5) and a cross section of a member around the rotator 32.

Vehicle 10 is a battery electric vehicle (BEV) including a battery that supplies electric power to a motor as a power source. The vehicle 10 may be, for example, a hybrid battery electric vehicle (HEV), a plug-in hybrid battery electric vehicle (PHEV), an engine-driven vehicle, or the like, and the type of the vehicle 10 is not limited.

As shown in FIG. 1, a front panel 12 is provided at the front end of the vehicle 10. The front panel 12 is provided with an opening 14 for introducing traveling wind into the vehicle body (power unit compartment). The opening 14 extends in the vehicle width direction (vehicle left-right direction) at a lower portion of the vehicle front end. The opening 14 is also referred to as a grille opening.

An air introduction passage 16 is provided behind the opening 14. A rotator 32 of the grille shutter device 30 is disposed in a front portion of the air introduction passage 16. A rear portion of the air introduction passage 16 extends rearward and upward, and a radiator 100 is disposed rearward of the air introduction passage 16. The majority, including the upper half of the radiator 100, is located above the opening 14.

The grille shutter device 30 is a device for adjusting the traveling air volume introduced into the vehicle body. When the opening 14 is opened by the grille shutter device 30, traveling air (outside air) flows from the opening 14 into the air introduction passage 16 and is guided to the radiator 100. On the other hand, when the opening 14 is closed by the grille shutter device 30, the flow of the traveling air into the air introduction passage 16 is blocked.

The grille shutter device 30 includes a rotator 32 rotatably provided around an axis CX extending in the vehicle-width-direction. The rotator 32 has a plurality of postures including a falling posture FP in which the opening 14 is fully closed, and a raised posture RP in which the opening 14 is fully opened (see a dashed-dotted line in FIG. 1).

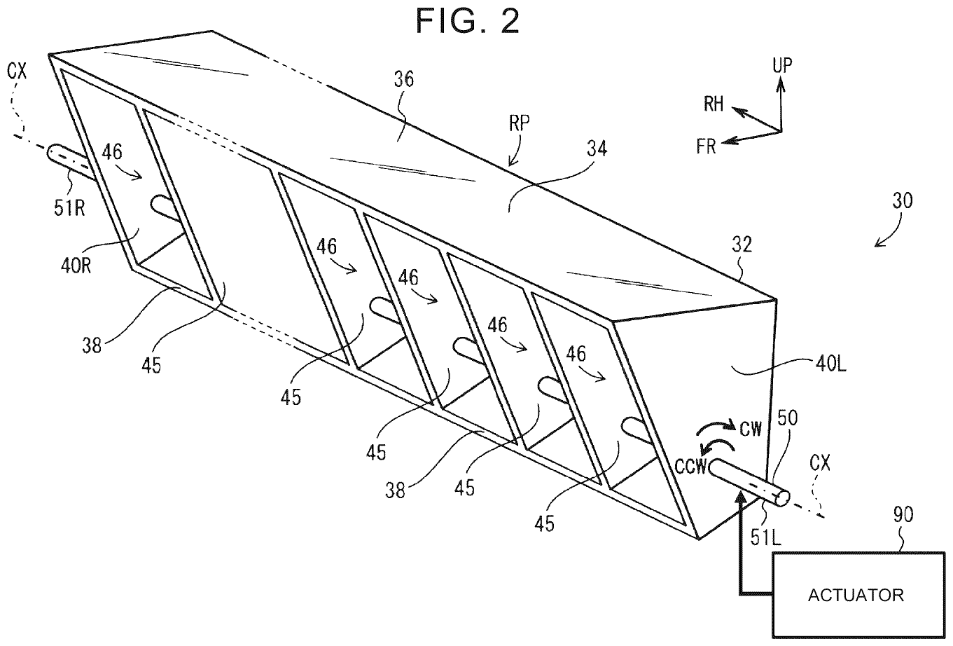

FIG. 2 is a perspective view showing a rotator 32 of the grille shutter device 30, showing a raised posture RP of the rotator 32. The rotator 32 includes a closing plate 34, a counter plate 38, a pair of side plates 40L, 40R, and a plurality of grille plates 45. The closing plate 34 extends in the vehicle width direction (vehicle left-right direction) with a constant width. The closing plate 34 has a design surface 36 that appears in front of the vehicles 10 in the falling posture FP of the rotator 32 (see FIG. 1).

As shown in FIG. 2, the counter plate 38 is provided to face the closing plate 34. The counter plate 38 extends in the vehicle width direction at a constant width narrower than the closing plate 34. The pair of side plates 40L, 40R connect both ends of the closing plate 34 and the counter plate 38. The plurality of grille plates 45 connect the closing plate 34 and the counter plate 38 to each other with a space therebetween in the vehicle-width direction between the pair of side plate 40L, 40R. Between the side plate 40L and the grille plate 45, between the adjacent grille plates 45, and between the grille plate 45 and the side plate 40R, the running air taken from the opening 14 (see FIG. 1) is an air flow path 46 flowing.

The rotator 32 includes a rotation shaft 50 having an axis CX. The rotation shaft 50 penetrates the side plate 40L, the plurality of grille plates 45, and the side plate 40R, and the outer peripheral surface of the rotation shaft 50 is fixed to the inner surfaces of the through holes of the side plate 40L, the plurality of grille plates 45, and the side plate 40R. Hereinafter, a part of the rotation shaft 50 extending outward from each of the pair of side plate 40L, 40R is referred to as a rod 51L, 51R. The grille shutter device 30 includes a bearing (not shown) that rotatably supports two rod 51L, 51R (a pair of rod 51L, 51R).

The grille shutter device 30 includes an actuator 90 that rotates the rotator 32 about the axis CX. The actuator 90 drives at least one of the pair of rod 51L, 51R. In this embodiment, the actuator 90 drives the rod 51L as shown in FIG. 2. For example, the actuator 90 includes a motor and a gear, and a ring-shaped gear (not shown) is fixed to an outer peripheral surface of the rod 51L. The actuator 90 rotates the rotator 32 by transmitting the driving force of the motor to the ring-shaped gear on the rod 51L via the gear. The actuator 90 may be controlled by a controller (not shown) including a microcomputer.

In this embodiment, the rotation shaft 50 is provided between the side plate 40L and the grille plate 45, between the adjacent grille plates 45, and between the grille plate 45 and the side plate 40R, but parts of these rotation shafts may be omitted. That is, the rotation shaft 50 may be composed of only a pair of rod 51L, 51R.

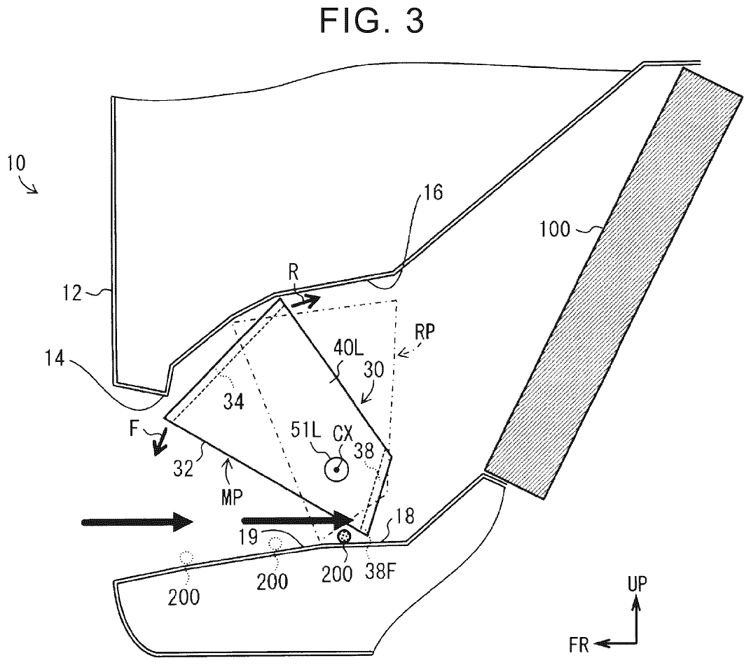

FIG. 3 is a partial cross-sectional side view showing the intermediate posture MP of the rotator 32. The intermediate posture MP is a posture between the falling posture FP and the raised posture RP, and is a posture in which the opening 14 is partially opened. In addition, there are not only one intermediate posture MP, but also a plurality of intermediate posture MP in which the tilt-in angle of the rotator 32 differs depending on the degree of opening the opening 14. The actuator 90 can form a plurality of intermediate posture MP in which the tilt angle of the rotator 32 differs in addition to the falling posture FP and the raised posture RP.

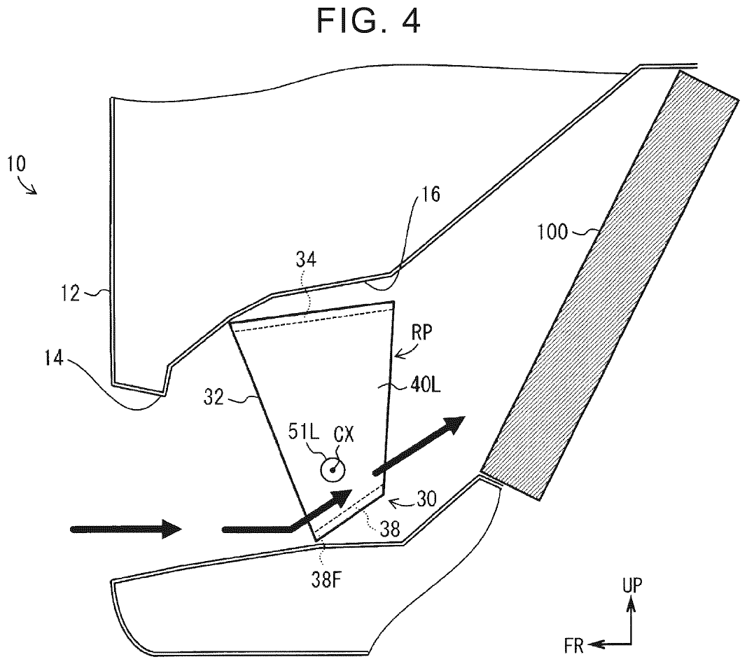

FIG. 4 is a partial cross-sectional side view showing the raised posture RP of the rotator 32. In FIGS. 3 and 4 and FIG. 5 to be described later, a thick line arrow indicates the flow of the traveling wind.

When the actuator 90 (see FIG. 2) drives the rotation shaft 50 in the counterclockwise direction ccw, the rotator 32 rotates in the falling direction F (see FIG. 3). On the other hand, when the actuator 90 drives the rotation shaft 50 in the clockwise direction cw, the rotator 32 rotates in the raising direction R. In the falling posture FP of the rotator 32, the closing plate 34 closed the opening 14, as shown in FIG. 1. In the raised posture RP of the rotator 32, as shown in FIGS. 2 and 4, a plurality of grille plates 45 appear at the back of the opening 14 in the front view of the vehicles.

As shown in FIG. 4, the counter plate 38 of the rotator 32 is inclined upward from the front toward the rear in the raised posture RP of the rotator 32. Further, an axis CX of the rotator 32 is positioned between the closing plate 34 and the counter plate 38. The front end 38F (see FIG. 4) of the counter plate 38 in the raised posture RP of the rotator 32 approaches the lower surface 18 of the air introduction passage 16 when the rotator 32 transitions from the falling posture FP to the raised posture RP (when rotating in the raising direction R in FIG. 3). The axis CX of the rotator 32 is provided so that the front end 38F of the counter plate 38 is positioned as described above.

Next, the operation and effect of the grille shutter device 30 of the above-described embodiment will be described.

According to the embodiment described above, the fully closed state of the opening 14 can be formed in the falling posture FP (see FIG. 1) of the rotator 32, and the fully open state of the opening 14 can be formed in the raised posture RP of the rotator 32. Therefore, the configuration of the grille shutter device 30 can be simplified. Opening and closing of the opening 14 of the vehicle front portion can be realized in a simple manner. Further, since the opening 14 is closed by one surface (design surface 36) of the closing plate 34, it is possible to suppress deterioration in aerodynamic performance during vehicle running. Further, in the falling posture FP (fully closed condition of the opening 14) of the rotator 32, since the plurality of grille plates 45 are positioned behind the closing plate 34 with a space therebetween in the vehicle width direction, it is possible to suppress the backward deflection deformation of the closing plate 34 due to the traveling wind. In addition, in the raised posture RP (fully opened state of the opening 14) of the rotator 32, since the plurality of grille plates 45 appear in the back of the opening 14, it is possible to suppress entry of foreign matter into the vehicle body from the outside.

Further, in the embodiment described above, as shown in FIG. 4, the counter plate 38 of the rotator 32 is inclined upward from the front toward the rear in the raised posture RP of the rotator 32. Therefore, the traveling wind taken in from the opening 14 (thick-line arrow in FIG. 4) can be guided upward in the vehicle body by the counter plate 38. A relatively large amount of traveling wind can be guided to the radiator 100.

Further, according to the configuration in which the counter plate 38 is inclined upward, as shown in FIG. 3, the rotator 32 is raised and rotated in the falling direction F from the raised posture RP (the fully opened state of the opening 14). At this time, the traveling wind (thick line arrow in FIG. 3) hits the front portion of the counter plate 38 before the rear portion, so that the rotation of the rotator 32 can be accelerated. Therefore, it is possible to reduce the required torque (output torque required for the actuator 90) of the actuator 90 that rotates the rotator 32.

Note that, in the configuration in which the counter plate 38 is inclined upward, when the rotator 32 rotates in the raising direction R and takes the raised posture RP, the rotator 32 needs to be rotated against the traveling wind hitting the front portion of the counter plate 38. Therefore, there is a disadvantage that the required torque of the actuator 90 increases. However, when the rotator 32 rotates in the raising direction R, the area of the traveling wind hits the closing plate 34 gradually decreases in accordance with the rotation, and the area of the air flow path 46 (see FIG. 2) with respect to the opening 14 gradually increases. Therefore, the output torque required for the actuator 90 is relatively small. On the other hand, when the rotator 32 rotates in the falling direction F, the area of the traveling wind hits the closing plate 34 gradually increases in accordance with the rotation, and the area of the air flow path 46 with respect to the opening 14 gradually decreases. Therefore, the output torque required for the actuator 90 is relatively large. That is, in the rotation in the falling direction F, since it is necessary to rotate the rotator 32 against the traveling wind hitting the closing plate 34, the required torque of the actuator 90 becomes relatively large. Therefore, when the rotator 32 rotates in the falling direction F, the rotation of the rotator 32 is accelerated at the front portion of the counter plate 38, so that the required torque of the actuator 90 can be reduced.

In the embodiment described above, as shown in FIG. 4, the axis CX of the rotator 32 is located between the closing plate 34 and the counter plate 38. The axis CX is located slightly above the counter plate 38. Therefore, the required torque of the actuator 90 for rotating the rotator 32 can be reduced as compared with the case where the axis CX is present in the counter plate 38. Note that the axis CX of the rotator 32 may be provided at or near an intermediate position between the lower end of the closing plate 34 and the upper end of the counter plate 38 in the raised posture RP of the rotator 32.

Further, in the embodiment described above, as shown in FIG. 3, when the rotator 32 rotates in the raising direction R and assumes the raised posture RP, the front end 38F of the counter plate 38 approaches the lower surface 18 of the air introduction passage 16. Therefore, when the rotator 32 rotates in the raising direction R, it is expected that the front end 38F of the counter plate 38 pushes the foreign matter 200 entering the lower surface 18 of the air introduction passage 16 forward and discharges the foreign matter from the opening 14. FIG. 3 shows a state in which the foreign matter 200 rolls forward.

It should be noted that the lower surface 18 of the air introduction passage 16 in which the front end 38F of the counter plate 38 approaches may be inclined downward from the rear toward the front. Alternatively, as shown in FIG. 3, the lower surface 18 of the air introduction passage 16 located in front of the rotator 32 in the raised posture RP may be formed as a descending surface 19 inclined downward from the rear toward the front. In this way, the foreign matter 200 rolls forward and is likely to be discharged from the opening 14.

Next, a rotator of another grille shutter device will be described. FIG. 5 is a partial cross-sectional side view illustrating a raised posture RP of a rotator 32A of another grille shutter device 30A. The rotator 32A is at a point having a number of air guide plate 70, is different from the rotator 32 described above.

The air guide plate 70 is provided between the side plate 40L and the grille plate 45 (see FIG. 2), between the adjacent grille plates 45, and between the grille plate 45 and the side plate 40R. As shown in FIG. 5, the plurality of air guide plates 70 are inclined upward from the front toward the rear in the raised posture RP of the rotator 32. In this embodiment, the plurality of air guide plates 70 are provided in the vicinity of the middle between the closing plate 34 and the counter plate 38 above the axis CX.

According to the rotator 32A, as shown in FIG. 5, the traveling wind taken in from the opening 14 (thick-line arrow in FIG. 5) can be guided upward in the vehicle body by the plurality of air guide plates 70 in addition to the counter plate 38. A relatively large amount of traveling wind can be guided to the radiator 100.

Further, according to the rotator 32A, when the rotator 32A rotates in the falling direction F (see FIG. 3) from the raised posture RP (fully opened state of the opening 14), the front portion of the counter plate 38 and the plurality of air guide plates 70, the traveling wind comes into contact earlier than the rear portion thereof. Thus, it is possible to promote the rotation of the rotator 32. Therefore, the required torque of the actuator 90 for rotating the rotator 32A can be reduced. Further, according to the rotator 32A, the plurality of air guide plates 70 can improve the stiffness of the rotator 32A.

What is claimed is:

1. A grille shutter device to be applied to a vehicle that introduces air into a vehicle body through an opening extending in a vehicle width direction at a vehicle front portion, the grille shutter device comprising a rotator disposed in an introduction passage for the air and rotatable about an axis extending in the vehicle width direction, wherein
the rotator includes:
a closing plate extending in the vehicle width direction;
a counter plate provided to face the closing plate;
a pair of side plates connecting both ends of the closing plate and the counter plate in the vehicle width direction; and
a plurality of grille plates connecting the closing plate and the counter plate with intervals in the vehicle width direction between the side plates, and
the rotator is configured to take, by being rotated about the axis by an actuator:
a falling posture in which the closing plate closes the opening; and
a raised posture in which the grille plates appear behind the opening in a front view of the vehicle.

2. The grille shutter device according to claim 1, wherein the counter plate of the rotator is inclined upward from a front to a rear in the raised posture of the rotator.

3. The grille shutter device according to claim 1, wherein the rotator further includes air guide plates each disposed between the grille plates and inclined upward from a front to a rear in the raised posture of the rotator.

4. The grille shutter device according to claim 1, wherein:
the axis of the rotator is located between the closing plate and the counter plate; and
a front end of the counter plate in the raised posture of the rotator approaches a lower surface of the introduction passage for the air when the rotator makes transition from the falling posture to the raised posture.

5. The grille shutter device according to claim 1, wherein:
the rotator includes a pair of rods having the axis and extending outward in the vehicle width direction from the side plates; and
at least one of the rods is rotated by the actuator.
